(19) United States
(12) Patent Application Publication
(10) Pub. No.: US 2023/0408986 A1
(43) Pub. Date: Dec. 21, 2023

(54) CONTROLLER

(71) Applicant: Fanuc Corporation, Minamitsuru-gun, Yamanashi (JP)

(72) Inventor: Shinichi Ozeki, Minamitsuru-gun, Yamanashi (JP)

(73) Assignee: Fanuc Corporation, Minamitsuru-gun, Yamanashi (JP)

(21) Appl. No.: 18/034,765

(22) PCT Filed: Nov. 12, 2021
(86) PCT No.: PCT/JP2021/041693

§ 371 Date: May 1, 2023

(30) Foreign Application Priority Data
Nov. 16, 2020 (JP) 2020-190262

(51) Int. Cl. G05B 13/02; B23Q 15/12

(52) U.S. Cl. CPC G05B 13/0245; B23Q 15/12

(57) ABSTRACT

A controller includes an offset value storage unit configured to store a plurality of tool offset values associated with a plurality of tools, respectively, an adjustment value storage unit configured to store an adjustment value used to adjust the plurality of tool offset values, and a calculation unit configured to calculate a plurality of adjustment offset values obtained by adjusting the plurality of tool offset values using the adjustment value.

### CROSS REFERENCE TO RELATED APPLICATIONS

This is the U.S. National Phase application of PCT/JP2021/041693, filed Nov. 12, 2021 which claims priority to Japanese Patent Application No. 2020-190262, filed Nov. 16, 2020, the disclosures of these applications being incorporated herein by reference in their entireties for all purposes.

### FIELD OF THE INVENTION

The present invention relates to a controller.

### BACKGROUND OF THE INVENTION

Conventionally, when trial machining of a workpiece is performed in a machine tool, a tool offset value of each tool is adjusted in order to prevent overcutting of the workpiece.

For example, when outer diameter turning of a workpiece is performed, before machining the workpiece, an operator performs an operation for adding a predetermined adjustment value to each of tool offset values of an outer diameter roughing tool and an outer diameter finishing tool set by a tool presetter, etc. (Patent Document 1).

In addition, when inner diameter turning of a workpiece is performed, the operator performs an operation for subtracting a predetermined adjustment value from each of tool offset values of an inner diameter roughing tool and an inner diameter finishing tool set by a tool presetter, etc. Then, the operator measures dimensions such as an outer diameter and an inner diameter of the workpiece after machining, and corrects the adjustment value so that the workpiece is machined to design dimensions. In this way, overcutting of the workpiece can be prevented.

### PATENT DOCUMENT

Patent Document 1: JP 2003-58216 A

### SUMMARY OF THE INVENTION

However, the operator needs to input adjustment values for adjusting each of a plurality of tool offset values one by one before trial machining. For this reason, a working time of the operator increases, and an operation time of a machine tool decreases. As a result, there is a risk that productivity in a factory will decrease.

An object of the invention is to provide a controller capable of reducing a working time of the operator and improving productivity in the factory.

A controller includes an offset value storage unit configured to store a plurality of tool offset values associated with a plurality of tools, respectively, an adjustment value storage unit configured to store an adjustment value used to adjust the plurality of tool offset values, and a calculation unit configured to calculate a plurality of adjustment offset values obtained by adjusting the plurality of tool offset values using the adjustment value.

According to the invention, it is possible to reduce a working time of an operator and improve productivity in a factory.

### BRIEF DESCRIPTION OF DRAWINGS

FIG. 1 is a diagram for describing an example of a hardware configuration of a machine tool;

FIG. 2 is a block diagram illustrating an example of functions of a controller;

FIG. 3 is a diagram for describing an example of a tool offset value of an outer diameter machining tool;

FIG. 4 is a diagram for describing an example of a tool offset value of a milling tool;

FIG. 5A is a diagram for describing adjustment of the tool offset value of the outer diameter machining tool;

FIG. 5B is a diagram for describing adjustment of the tool offset value of the outer diameter machining tool;

FIG. 6 is a diagram illustrating an example of a display screen displayed by a display unit on a display device;

FIG. 7 is a diagram illustrating an example of a tool offset value of an inner diameter machining tool;

FIG. 8A is a diagram for describing adjustment of the tool offset value of the inner diameter machining tool;

FIG. 8B is a diagram for describing adjustment of the tool offset value of the inner diameter machining tool;

FIG. 9 is a diagram illustrating an example of a display screen displaying the tool offset value of the inner diameter machining tool;

FIG. 10 is a diagram illustrating an example of a display screen displaying tool offset values of the outer diameter machining tool and the inner diameter machining tool;

FIG. 11 is a diagram for describing a virtual cutting edge number;

FIG. 12A is a diagram illustrating a specific example of a tool corresponding to each virtual cutting edge number;

FIG. 12B is a diagram illustrating a specific example of the tool corresponding to each virtual cutting edge number;

FIG. 12C is a diagram illustrating a specific example of the tool corresponding to each virtual cutting edge number;

FIG. 12D is a diagram illustrating a specific example of the tool corresponding to each virtual cutting edge number;

FIG. 13 is a block diagram illustrating an example of functions of a controller including an acquisition unit;

FIG. 14 is a diagram illustrating an example of a machining program;

FIG. 15 is a diagram illustrating an example of a display screen when an adjustment value storage unit stores a plurality of adjustment values;

FIG. 16 is a diagram illustrating an example of a display screen when an offset value storage unit stores adjustment value application information;

FIG. 17 is a diagram illustrating an example of a display screen when a plurality of adjustment values is applied to one tool offset value; and

FIG. 18 is a diagram illustrating an example of a display screen when the offset value storage unit stores adjustment value application information and cutting edge information.

### DETAILED DESCRIPTION OF EMBODIMENTS OF THE INVENTION

An embodiment of the invention will be described below with reference to the drawings. Note that not all combinations of features described in the following embodiment are necessarily required to solve the problem. Further, more detailed description than necessary may be omitted. In addition, the following description of the embodiment and drawings are provided for those skilled in the art to fully understand the invention, and are not intended to limit the scope of the claims.

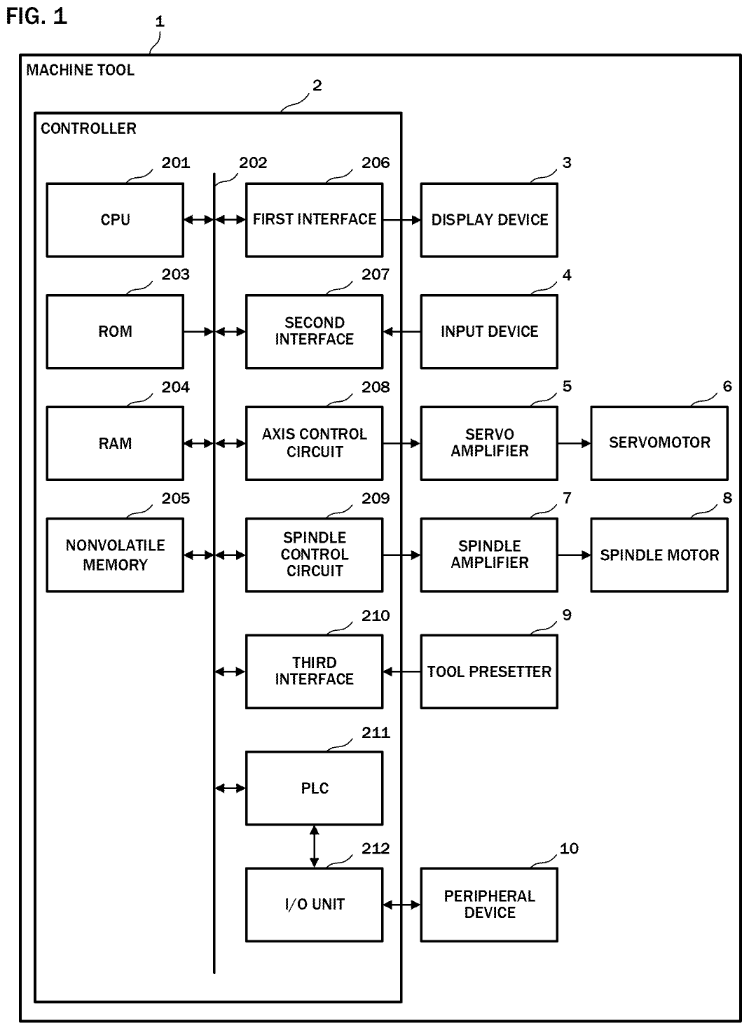

FIG. 1 is a diagram for describing an example of a hardware configuration of a machine tool. The machine tool 1 is a machine that uses a tool to machine a workpiece. The machine tool 1 machines the workpiece using tools such as a cutting tool, an end mill, and a drill. For example, the machine tool 1 is a lathe, a machining center, or a multitasking machine.

The machine tool 1 includes a controller 2, a display device 3, an input device 4, a servo amplifier 5 and a servomotor 6, a spindle amplifier 7 and a spindle motor 8, a tool presetter 9, and a peripheral device 10.

The controller 2 is a device that controls the entire machine tool 1. The controller 2 is, for example, a numerical controller.

The controller 2 includes a CPU (Central Processing Unit) 201, a bus 202, a ROM (Read Only Memory) 203, a RAM (Random Access Memory) 204, and a nonvolatile memory 205.

The CPU 201 is a processor that controls the entire controller 2 according to a system program. The CPU 201 reads a system program, etc. stored in the ROM 203 via the bus 202. In addition, the CPU 201 controls the servomotor 6, the spindle motor 8, etc. according to a machining program to machine the workpiece.

The bus 202 is a communication path that connects respective pieces of hardware in the controller 2 to each other. The respective pieces of hardware in the controller 2 exchange data via the bus 202.

For example, the ROM 203 is a storage device that stores a system program for controlling the entire controller 2 and an analysis program for analyzing various data.

The RAM 204 is a storage device that temporarily stores various data. The RAM 204 temporarily stores data related to a tool path calculated by analyzing a machining program, data for display, data input from the outside, etc. The RAM 204 functions as a work area for processing various data by the CPU 201.

The nonvolatile memory 205 is a storage device that retains data even when power of the machine tool 1 is turned off and power is not supplied to the controller 2. The nonvolatile memory 205 includes, for example, an SSD (Solid State Drive). The nonvolatile memory 205 stores, for example, tool information on tool specifications input from the input device 4, a tool offset value, information indicating a tool lifespan, and a machining program.

The controller 2 further includes a first interface 206, a second interface 207, an axis control circuit 208, a spindle control circuit 209, a third interface 210, a PLC (Programmable Logic Controller) 211, and an I/O unit 212.

The first interface 206 is an interface that connects the bus 202 and the display device 3 to each other. For example, the first interface 206 transmits various data processed by the CPU 201 to the display device 3.

The display device 3 is a device that receives various data via the first interface 206 and displays the various data. The display device 3 displays, for example, a machining program, a tool offset value, etc. stored in the nonvolatile memory 205. The display device 3 is a display such as an LCD (Liquid Crystal Display).

The second interface 207 is an interface that connects the bus 202 and the input device 4 to each other. For example, the second interface 207 transmits data input from the input device 4 to the CPU 201 via the bus 202.

The input device 4 is a device for inputting various data. For example, the input device 4 receives input of a tool offset value and tool information, and transmits input data to the nonvolatile memory 205 via the second interface 207. For example, the input device 4 is a keyboard and a mouse. Note that, for example, the input device 4 and the display device 3 may be configured as one device such as a touch panel.

The axis control circuit 208 is a control circuit that controls the servomotor 6. The axis control circuit 208 receives a control command from the CPU 201 and outputs a command for driving the servomotor 6 to the servo amplifier 5. For example, the axis control circuit 208 transmits a torque command for controlling torque of the servomotor 6 to the servo amplifier 5.

The servo amplifier 5 receives a command from the axis control circuit 208 and supplies power to the servomotor 6.

The servomotor 6 is a motor driven by receiving power supply from the servo amplifier 5. For example, the servomotor 6 is coupled to a ball screw that moves a tool post, a spindle head, and a table. By driving the servomotor 6, components of the machine tool 1 such as the tool post, the spindle head, and the table move, for example, in an X-axis direction, a Y-axis direction, or a Z-axis direction.

The spindle control circuit 209 is a control circuit for controlling the spindle motor 8. The spindle control circuit 209 receives a control command from the CPU 201 and outputs a command for driving the spindle motor 8 to the spindle amplifier 7. For example, the spindle control circuit 209 transmits a torque command for controlling torque of the spindle motor 8 to the spindle amplifier 7.

The spindle amplifier 7 receives a command from the spindle control circuit 209 and supplies power to the spindle motor 8.

The spindle motor 8 is a motor driven by receiving power supply from the spindle amplifier 7. The spindle motor 8 is coupled to a spindle to rotate the spindle.

The third interface 210 is an interface that connects the bus 202 and the tool presetter 9 to each other. The third interface 210 transmits a tool offset value detected by the tool presetter 9 to the nonvolatile memory via the bus 202.

The tool presetter 9 is a device disposed inside the machine tool 1 to detect tool offset values of a plurality of tools. The tool presetter 9 includes a contact sensor. In addition, a reference point serving as a standard for detecting a tool offset value is set in advance on a spindle to which a tool is attached. The tool presetter 9 detects a tool offset value based on a position of the reference point at the timing when the tool comes into contact with the contact sensor. The tool presetter 9 transmits the detected tool offset value to the RAM 204.

The PLC 211 executes a ladder program to control the peripheral device 10. The PLC 211 controls the peripheral device 10 via the I/O unit 212.

The I/O unit 212 is an interface that connects the PLC 211 and the peripheral device 10 to each other. The I/O unit 212 transmits a command received from the PLC 211 to the peripheral device 10.

The peripheral device 10 is a device installed in the machine tool 1 to perform an auxiliary operation when the machine tool 1 machines a workpiece. The peripheral device may be a device installed around the machine tool 1. For example, the peripheral device 10 is a tool changer and a robot such as a manipulator.

Next, an example of functions of the controller 2 will be described.

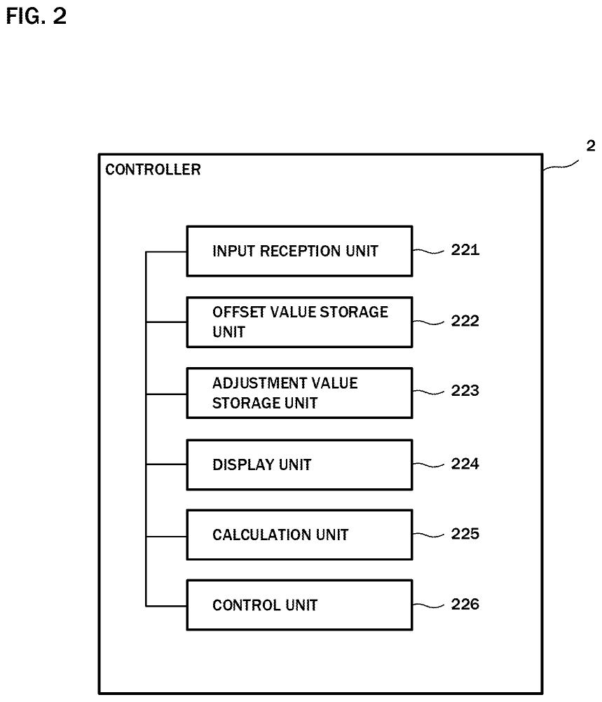

FIG. 2 is a block diagram illustrating an example of the functions of the controller 2. For example, the controller 2 includes an input reception unit 221, an offset value storage unit 222, an adjustment value storage unit 223, a display unit 224, a calculation unit 225, and a control unit 226.

For example, the input reception unit 221, the display unit 224, the calculation unit 225, and the control unit 226 are realized by the CPU 201 performing arithmetic processing using the RAM 204 as a work area by using a system program and a control program stored in the ROM 203, and various data.

In addition, for example, the offset value storage unit and the adjustment value storage unit 223 are realized by data input from the input device 4 and the tool presetter 9 or a processing result of arithmetic processing in the CPU 201 being stored in the RAM 204 or the nonvolatile memory 205.

The input reception unit 221 receives, from the tool presetter 9, input of the tool offset values of the plurality of tools used for machining.

The tool offset value is data indicating a distance from the reference point to a tool cutting edge. When the machine tool 1 is a lathe-based multitasking machine or a machining center, the tool offset value is data indicating a distance from a reference point of the spindle to which the tool is attached to the tool cutting edge. By setting a tool offset value for each tool, a machining shape can be designated using coordinate values in a workpiece coordinate system in a machining program regardless of a tool used.

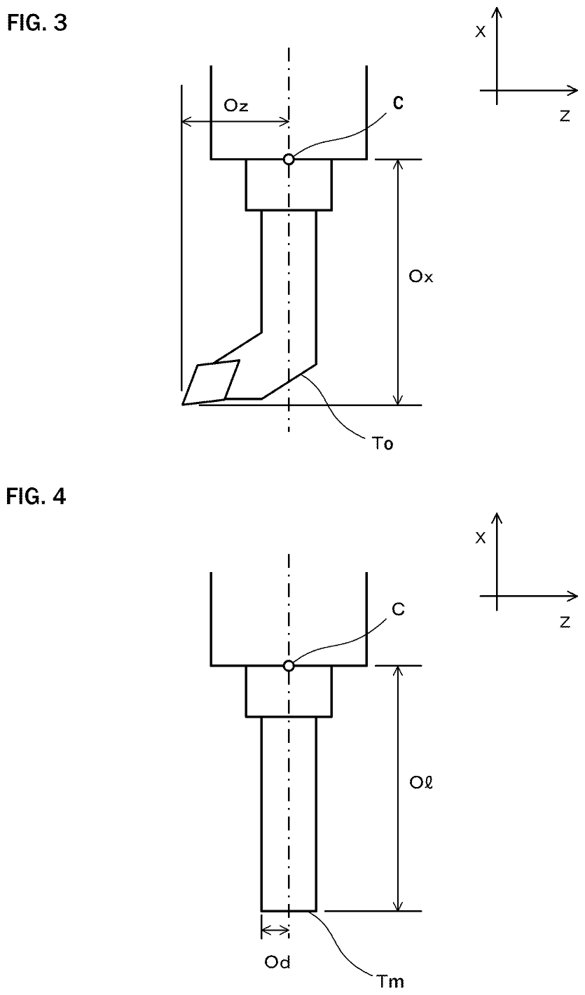

FIG. 3 is a diagram illustrating an example of a tool offset value of an outer diameter machining tool. For example, the outer diameter machining tool To is a cutting tool. A reference point C is set, for example, at a center of a spindle end. For example, the tool offset value includes tool offset values Ox in the X-axis direction and Oz in the Z-axis direction. As illustrated in FIG. 3, the tool offset value Ox in the X-axis direction is a value indicating a distance from the reference point C to a cutting edge in the X-axis direction. The tool offset value Oz in the Z-axis direction is a value indicating a distance from the reference point C to the cutting edge in the Z-axis direction.

When the outer diameter machining tool To is attached to the spindle, the reference point C is located in a positive direction of the X-axis and a positive direction of the Z-axis with respect to the cutting edge of the tool. In this case, the tool offset value Ox in the X-axis direction and the tool offset value Oz in the Z-axis direction are both positive values.

FIG. 4 is a diagram illustrating an example of a tool offset value of a milling tool. For example, the milling tool Tm is an end mill or a milling cutter. For example, a reference point C is a center of a spindle end. For example, the tool offset value includes a value indicating tool length compensation Ol and a value indicating tool radius compensation Od. A value of the tool length compensation Ol is a value indicating a distance from the reference point C to a tip of the milling tool Tm. A value of the tool radius compensation Od is a value indicating a distance from the reference point C to an outer circumference of the milling tool Tm. That is, the value of the tool radius compensation Od is a value indicating a radius of the milling tool Tm.

When the milling tool Tm is attached to the spindle, the reference point C is located in the positive direction of the X-axis with respect to the tip of the tool. In this case, the value of the tool length compensation Ol becomes a positive value. In addition, the value of the tool radius compensation Od is a positive value at all times.

Here, returning to FIG. 2, description of the functions of the controller 2 will be continued.

The offset value storage unit 222 stores a plurality of tool offset values associated with a plurality of tools, respectively. The offset value storage unit 222 stores a tool offset value received by the input reception unit 221 in association with each tool. For example, the offset value storage unit 222 stores the tool offset values Ox and Oz in the X-axis direction and the Z-axis direction of each tool in association with tool numbers of each tool.

Further, the input reception unit 221 receives input of adjustment values used to adjust a plurality of tool offset values from the input device 4. The adjustment values refer to numerical information used to collectively adjust the plurality of tool offset values. Here, adjustment of the tool offset values will be described.

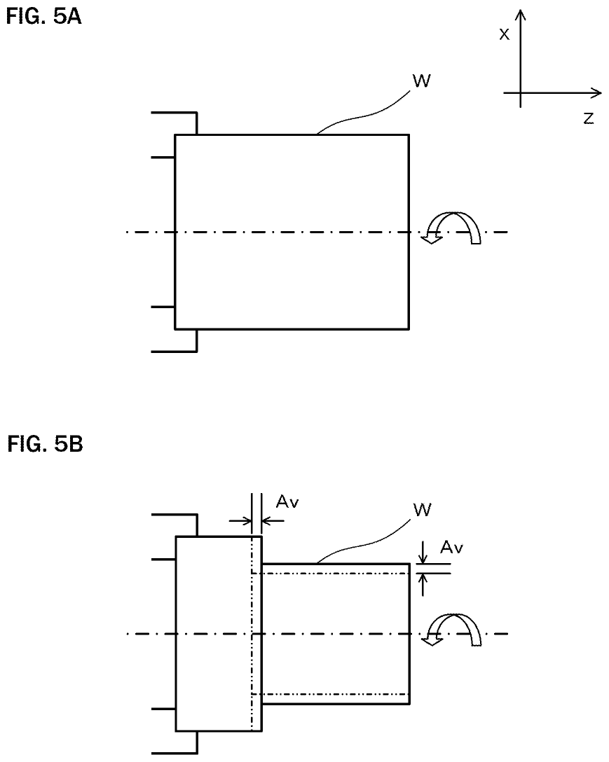

FIGS. 5A and 5B are diagrams for describing adjustment of tool offset values of the outer diameter machining tool To. When an outer diameter of a cylindrical workpiece W illustrated in FIG. 5A is machined to manufacture a product having a shape illustrated in FIG. 5B, in trial machining, each of a tool offset value of an outer diameter roughing tool and a tool offset value of an outer diameter finishing tool stored in the offset value storage unit 222 is adjusted. Here, trial machining means first workpiece machining when a plurality of workpieces having the same shape is successively machined. Alternatively, trial machining means first workpiece machining after a machining program is read.

In adjustment of the tool offset value of the outer diameter roughing tool, for example, an adjustment value Av of 0.2 [mm] is added to the tool offset value Ox in the X-axis direction and the tool offset value Oz in the Z-axis direction, respectively. Similarly, the adjustment value Av of 0.2 [mm] is added to the tool offset value Ox in the X-axis direction and the tool offset value Oz in the Z-axis direction of the outer diameter finishing tool, respectively.

In this way, in trial machining, machining is performed so that an outer diameter dimension and a longitudinal dimension are increased by the adjustment value Av. When trial machining is completed, the outer diameter dimension and the longitudinal dimension are measured, and the adjustment value Av is corrected so that the workpiece W is machined to design dimensions in subsequent machining.

For example, when the outer diameter dimension of the workpiece W machined using the tool offset value to which the adjustment value Av is added is greater than the design dimension by 0.21 [mm], machining needs to be performed using values obtained by subtracting 0.21 [mm] from each of the tool offset value Ox in the X-axis direction of the outer diameter roughing tool and the tool offset value Ox in the X-axis direction of the outer diameter finishing tool.

In addition, when machining is performed so that the longitudinal dimension of the workpiece W is greater than the design dimension by 0.19 [mm], machining needs to be performed using values obtained by subtracting 0.19 [mm] from each of the tool offset value Oz in the Z-axis direction of the outer diameter roughing tool and the tool offset value Oz in the Z-axis direction of the outer diameter finishing tool. By adjusting the tool offset value in this way, the workpiece can be machined to design dimensions.

For example, the input reception unit 221 receives input of the adjustment value Av used to collectively adjust the tool offset values Ox in the X-axis direction of the outer diameter roughing tool and the outer diameter finishing tool. In addition, the input reception unit 221 receives input of the adjustment value Av used to collectively adjust the tool offset values Oz in the Z-axis direction of the outer diameter roughing tool and the outer diameter finishing tool.

In addition, the input reception unit 221 may receive input of the adjustment value Av used to collectively adjust the tool offset values Ox in the X-axis direction of the inner diameter roughing tool and the inner diameter finishing tool. In addition, the input reception unit 221 may receive input of the adjustment value Av used to collectively adjust the tool offset values Oz in the Z-axis direction in the inner diameter roughing tool and the inner diameter finishing tool.

Here, returning to FIG. 2, description of the functions of the controller 2 will be continued.

The adjustment value storage unit 223 stores the adjustment value Av received by the input reception unit 221 and used for adjusting a plurality of tool offset values.

The display unit 224 causes the display device 3 to display the tool offset values of the plurality of tools stored in the offset value storage unit 222 and the adjustment value Av stored in the adjustment value storage unit 223.

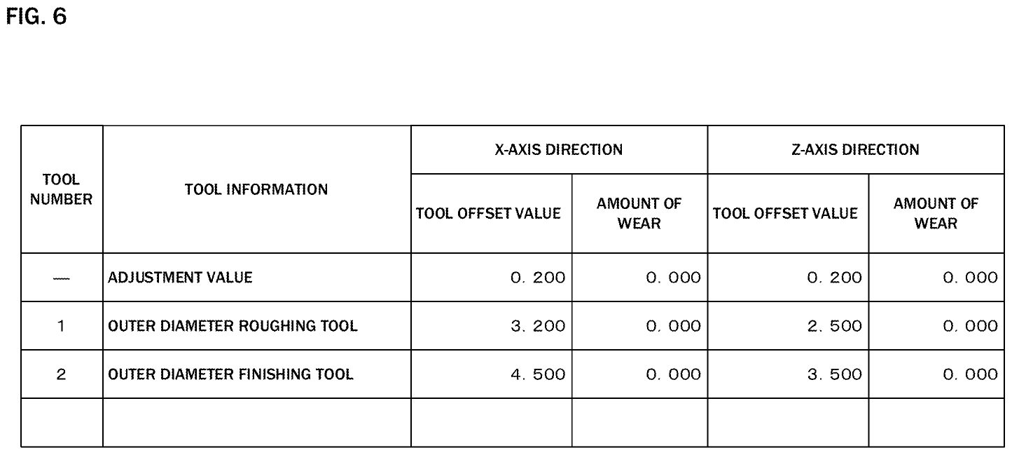

FIG. 6 is a diagram illustrating an example of a display screen that the display unit 224 causes the display device 3 to display. The display screen displays a tool number, tool information, the tool offset value Ox and the amount of wear in the X-axis direction, and the tool offset value Oz and the amount of wear in the Z-axis direction of each tool. In addition, the adjustment value Av in the X-axis direction and the adjustment value Av in the Z-axis direction are displayed in a row above a row in which information related to a tool of a tool number “1” is displayed.

Here, returning to FIG. 2, description of the functions of the controller 2 will be continued.

The calculation unit 225 calculates a plurality of adjustment offset values obtained by adjusting a plurality of tool offset values using the adjustment value Av.

In the example illustrated in FIG. 6, the calculation unit 225 adds an adjustment value Av “0.200” to a tool offset value Ox “3.200” in the X-axis direction of the outer diameter roughing tool to calculate an adjustment offset value “3.400”. Similarly, the adjustment value Av “0.200” is added to a tool offset value Oz “2.500” in the Z-axis direction to calculate an adjustment offset value “2.700”.

Further, the calculation unit 225 adds the adjustment value Av “0.200” to a tool offset value Ox “4.500” in the X-axis direction of the outer diameter finishing tool to calculate an adjustment offset value “4.700”. Similarly, the adjustment value Av “0.200” is added to a tool offset value Oz “3.500” in the Z-axis direction to calculate an adjustment offset value “3.700”.

For example, the adjustment offset value calculated by the calculation unit may be stored in a storage unit such as an adjustment offset value storage unit (not illustrated).

Here, returning to FIG. 2, description of the functions of the controller 2 will be continued.

For example, the control unit 226 controls the servomotor 6 and the spindle motor 8 to machine the workpiece. The control unit 226 analyzes a machining program and calculates a movement path along which the tool moves, a feed speed of the tool, and a rotation speed of the spindle during machining of the workpiece W. The control unit 226 rotates the spindle at the calculated rotation speed and controls the servomotor 6 so that the tool moves along the calculated tool path at the calculated feed speed. In this way, the workpiece W is machined. At this time, the control unit 226 performs position control of the tool based on the adjustment offset value calculated by the calculation unit 225.

As described above, the controller 2 according to the present embodiment includes the offset value storage unit 222 that stores a plurality of tool offset values associated with a plurality of tools, respectively, the adjustment value storage unit 223 that stores the adjustment value Av used to adjust the plurality of tool offset values, and the calculation unit 225 that calculates a plurality of adjustment offset values obtained by adjusting the plurality of tool offset values using the adjustment value Av.

Therefore, the operator does not need to input a plurality of adjustment values Av when adjusting a plurality of tool offset values. In other words, it is sufficient to input one adjustment value Av for collectively adjusting the plurality of tool offset values. As a result, the working time of the operator can be reduced, and productivity in the factory can be improved.

Note that, in the embodiment described above, the controller 2 is provided in the machine tool 1. However, for example, the controller 2 may be provided in a management server installed at a location separated from the machine tool 1.

The embodiment described above is an example in which outer diameter turning is performed using the outer diameter machining tool To. However, an example in which inner diameter turning is performed using an inner diameter machining tool will be described below.

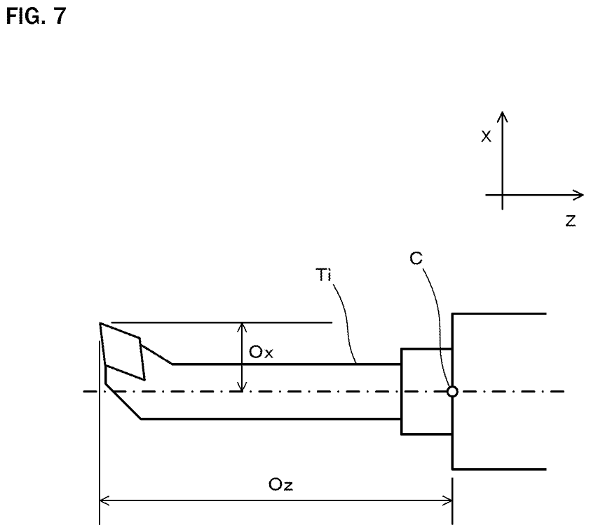

FIG. 7 is a diagram illustrating an example of a tool offset value of the inner diameter machining tool. For example, a reference point C is a center of a spindle end. The tool offset value includes, for example, tool offset values Ox and Oz in the X-axis direction and the Z-axis direction. As illustrated in FIG. 7, the tool offset value Ox in the X-axis direction is a value indicating a distance from the reference point C to a cutting edge in the X-axis direction. In addition, the tool offset value Oz in the Z-axis direction is a value indicating a distance from the reference point C to the cutting edge in the Z-axis direction.

When an inner diameter machining tool Ti illustrated in FIG. 7 is attached to the spindle, the reference point C is located in a negative direction of the X-axis and a positive direction of the Z-axis with respect to the cutting edge of the tool. In this case, the tool offset value Ox in the X-axis direction is a negative value, and the tool offset value Oz in the Z-axis direction is a positive value.

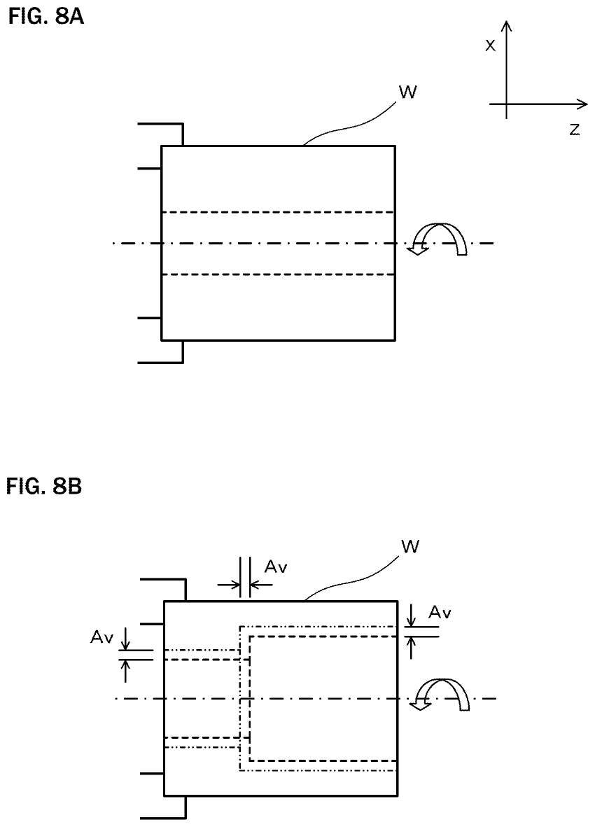

FIGS. 8A and 8B are diagrams illustrating adjustment of a tool offset value of the inner diameter machining tool Ti. When an inner diameter of a cylindrical workpiece illustrated in FIG. 8A is machined to manufacture a product having a shape illustrated in FIG. 8B, in trial machining, each of a tool offset value of an inner diameter roughing tool and a tool offset value of an inner diameter finishing tool stored in the offset value storage unit 222 is adjusted.

For example, the adjustment value Av of 0.2 [mm] is subtracted from the tool offset value Ox in the X-axis direction of the inner diameter roughing tool, and the adjustment value Av of 0.2 [mm] is added to the tool offset value Oz in the Z-axis direction. Similarly, the adjustment value Av of 0.2 [mm] is subtracted from the tool offset value Ox in the X-axis direction of the inner diameter finishing tool, and the adjustment value Av of 0.2 [mm] is added to the tool offset value Oz in the Z-axis direction.

In this way, in trial machining, machining is performed so that an inner diameter dimension is decreased by the adjustment value Av, and a longitudinal dimension is increased by the adjustment value Av. When trial machining is completed, the inner diameter dimension, the longitudinal dimension, etc. are measured, and the adjustment value Av is corrected so that the workpiece W is machined to design dimensions in subsequent machining.

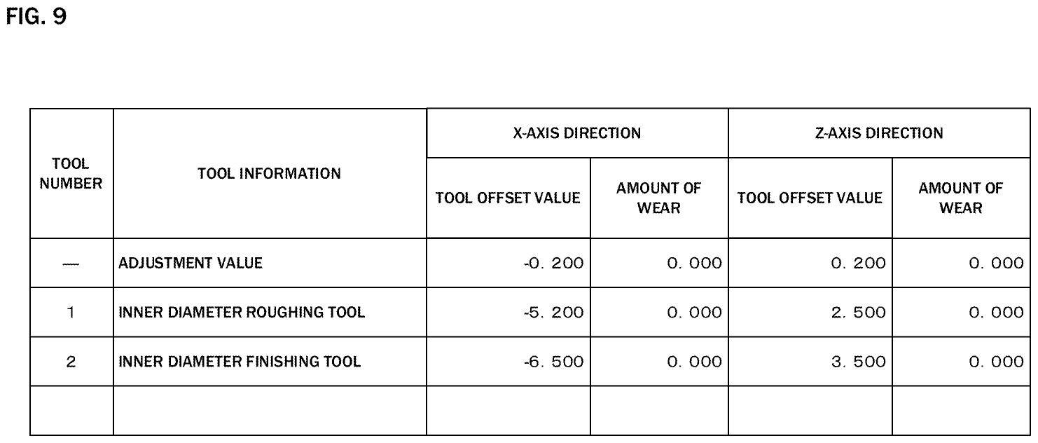

FIG. 9 is a diagram illustrating an example of a display screen that displays the tool offset value of the inner diameter machining tool Ti. In the example illustrated in FIG. 9, the adjustment value storage unit 223 stores −0.200 [mm] as the adjustment value Av for adjusting the tool offset value Ox in the X-axis direction, and 0.200 [mm] as the adjustment value Av for adjusting the tool offset value Oz in the Z-axis direction.

The calculation unit 225 calculates an adjustment offset value by adding the adjustment value Av of −0.200 [mm] to the tool offset value Ox in the X-axis direction of the inner diameter roughing tool. In addition, the calculation unit 225 calculates an adjustment offset value by adding the adjustment value Av of 0.200 [mm] to the tool offset value Oz in the Z-axis direction of the inner diameter roughing tool.

Similarly, the calculation unit 225 calculates an adjustment offset value by adding the adjustment value Av of −0.200 [mm] to the tool offset value Ox in the X-axis direction of the inner diameter finishing tool. Further, the calculation unit 225 calculates an adjustment offset value by adding the adjustment value Av of 0.200 [mm] to the tool offset value Oz in the Z-axis direction of the inner diameter finishing tool.

In this way, in trial machining, machining is performed so that an inner diameter dimension is decreased by the adjustment value Av, and a longitudinal dimension is increased by the adjustment value Av. When trial machining is performed, the inner diameter dimension and longitudinal dimension are measured, and the adjustment value Av is corrected according to the measured values. As a result, it is possible to machine a workpiece undergoing trial machining and workpieces to be continuously machined thereafter to design dimensions.

In the embodiment described above, the adjustment value Av stored in the adjustment value storage unit 223 is added to the plurality of tool offset values by the calculation unit 225. However, the calculation unit 225 may calculate a plurality of adjustment offset values by adding the adjustment value Av to each of the plurality of tool offset values or subtracting the adjustment value Av from each of the plurality of tool offset values based on the plurality of tool offset values stored in association with the plurality of tools.

For example, when the tool offset value in the X-axis direction is a positive value, this tool is the outer diameter machining tool To. Therefore, the calculation unit 225 adds the adjustment value Av to the tool offset value in the X-axis direction.

On the other hand, when the tool offset value in the X-axis direction is a negative value, this tool is the inner diameter machining tool Ti. Therefore, the calculation unit 225 subtracts the adjustment value Av from the tool offset value in the X-axis direction.

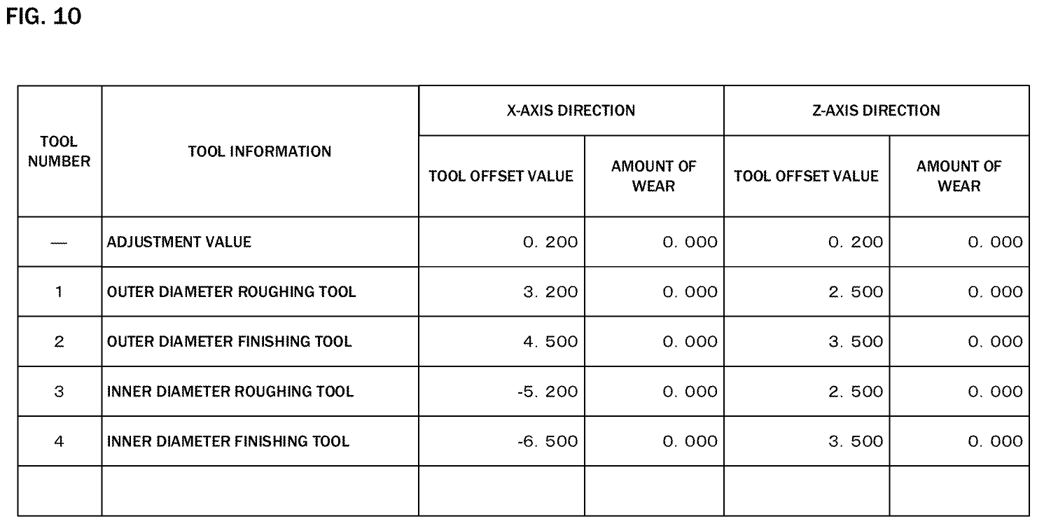

FIG. 10 is a diagram illustrating an example of a display screen that displays the tool offset values of the outer diameter machining tool To and the inner diameter machining tool Ti. In the example illustrated in FIG. 10, the tool offset value Ox in the X-axis direction of each of the outer diameter roughing tool and the outer diameter finishing tool is a positive value. Therefore, the calculation unit 225 adds the adjustment value Av to the tool offset value Ox in the X-axis direction of each of the outer diameter roughing tool and the outer diameter finishing tool. On the other hand, the tool offset value Ox in the X-axis direction of each of the inner diameter roughing tool and the inner diameter finishing tool is a negative value. Therefore, the calculation unit 225 subtracts the adjustment value Av from the tool offset value Ox in the X-axis direction of each of the inner diameter roughing tool and the inner diameter finishing tool.

In addition, the tool offset value Oz in the Z-axis direction of each of the outer diameter roughing tool, the outer diameter finishing tool, the inner diameter roughing tool, and the inner diameter finishing tool is a positive value. Therefore, the calculation unit 225 adds the adjustment value Av to the tool offset value Oz in the Z-axis direction of each tool. In this way, even when both outer diameter machining and inner diameter machining are performed, it is sufficient that the operator inputs one adjustment value Av used to adjust each tool offset value in the X-axis direction and one adjustment value Av used to adjust each tool offset value in the Z-axis direction. As a result, the working time of the operator can be reduced, and productivity in the factory can be improved.

Note that the calculation unit 225 may calculate a plurality of adjustment offset values by adding the adjustment value Av to each of the plurality of tool offset values or subtracting the adjustment value Av from each of the plurality of tool offset values based on tool information stored in association with each of the plurality of tools. Here, the tool information is information indicating a name or type of each of the plurality of tools. The tool name is, for example, a product name or a model number of each tool. Further, the type of tool includes an outer diameter roughing tool, an outer diameter finishing tool, an inner diameter roughing tool, an inner diameter finishing tool, a milling tool, and a drill.

Referring to information indicating a name or type of each of the plurality of tools, the calculation unit 225 calculates an adjustment offset value by determining whether to add the adjustment value Av to the tool offset value of each tool or to subtract the adjustment value Av from the tool offset value of each tool.

Further, the tool information may include cutting edge information indicating a direction in which the cutting edge of each of the plurality of tools is directed. The cutting edge information is, for example, a virtual cutting edge number. The virtual cutting edge number is a number indicating a cutting edge position on the assumption that a cutting edge R is not formed in a tool on which the cutting edge R is formed. For example, the cutting edge information is input by the operator from the input device 4. For example, the cutting edge information may be acquired by the tool presetter 9 and input from the tool presetter 9.

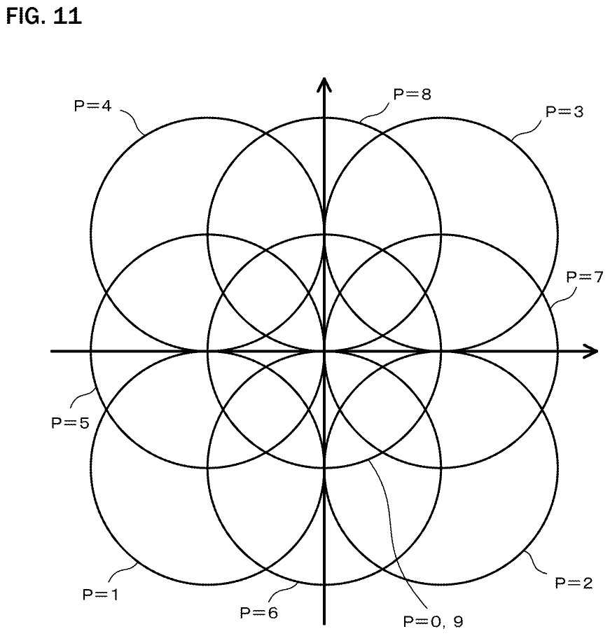

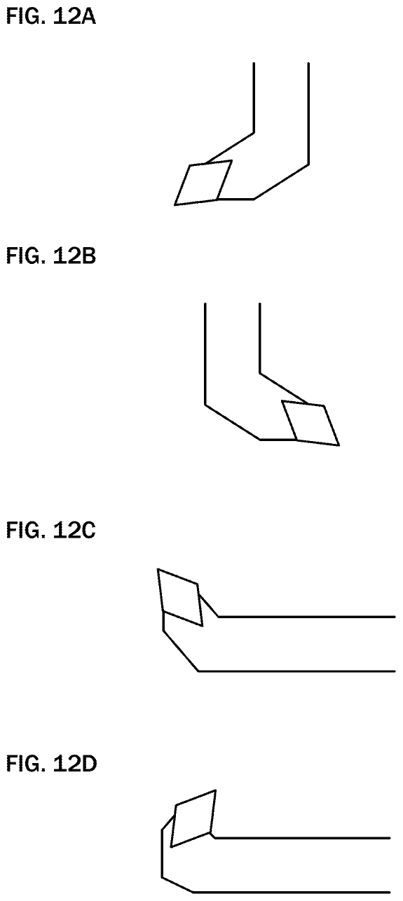

FIG. 11 is a diagram for describing the virtual cutting edge number. FIGS. 12A to 12D are diagrams each illustrating a specific example of a tool corresponding to each virtual cutting edge number. Each circle illustrated in FIG. 11 indicates a position of a tool on the assumption that an intersection of a vertical axis and a horizontal axis is a cutting edge position. For example, a tool of a tool cutting edge number P=3 of FIG. 11 is an outer diameter machining tool To illustrated in FIG. 12A. In addition, for example, a tool of a tool cutting edge number P=4 is an outer diameter machining tool To illustrated in FIG. 12B. In addition, for example, a tool of a tool cutting edge number P=2 is an inner diameter machining tool Ti illustrated in FIG. 12C. In addition, for example, a tool of a tool cutting edge number P=1 is an inner diameter machining tool Ti illustrated in FIG. 12D. In addition, for example, a tool of a tool cutting edge number P=0 is a milling tool such as an end mill.

Using such cutting edge information, the calculation unit 225 calculates an adjustment offset value by determining whether to add the adjustment value Av to the tool offset value of each tool or to subtract the adjustment value Av from the tool offset value of each tool. In this way, even when a plurality of machining operations such as outer diameter machining and inner diameter machining is performed, it is sufficient that the operator inputs one adjustment value Av used to adjust each tool offset value in the X-axis direction and one adjustment value Av used to adjust each tool offset value in the Z-axis direction. As a result, the working time of the operator can be reduced, and productivity in the factory can be improved.

The controller 2 may further include an acquisition unit that acquires cutting direction information indicating a cutting direction of each of the plurality of tools from a machining program. In this case, the calculation unit 225 may calculate a plurality of adjustment offset values by adding the adjustment value Av to each of the plurality of tool offset values or subtracting the adjustment value Av from each of the plurality of tool offset values based on the cutting direction information.

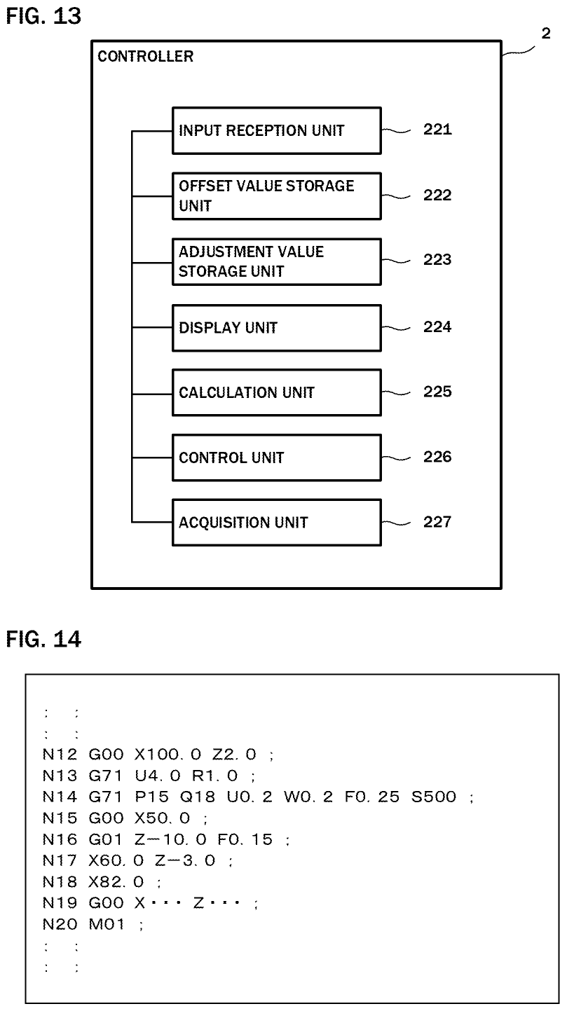

FIG. 13 is a block diagram illustrating functions of the controller 2 including the acquisition unit. For example, the acquisition unit 227 is realized by the CPU 201 performing arithmetic processing using the RAM 204 as a work area by using a system program, a control program stored in the ROM 203 and various data.

The acquisition unit 227 acquires cutting direction information indicating a cutting direction of each of the plurality of tools from a machining program. For example, the acquisition unit 227 acquires cutting direction information indicating a tool cutting direction used in a roughing cycle in the machining program.

FIG. 14 is a diagram illustrating an example of a machining program. The machining program illustrated in FIG. 14 is a machining program for executing roughing of a workpiece using a roughing cycle command “G71”. In the machining program, the tool is positioned at a machining start position “X100.0Z2.0” by “G00X100.0Z2.0” described in a sequence number “N12”. In addition, a roughing cycle command “G71U4.0R1.0” described in a sequence number “N13” commands a cutting depth of 4.0 [mm] and a retract amount of 1.0 [mm] during roughing.

In addition, a roughing cycle command “G71P15Q18U0.2W0.2F0.25S500” described in a sequence number “N14” commands a first sequence number “N15” that defines a finish shape, a last sequence number “N18” that defines the finish shape, a finishing allowance of 0.2 [mm] in the X-axis direction, a finishing allowance of 0.2 [mm] in the Z-axis direction, a feed rate of 0.25 [mm/rev], and a rotation speed of 500 [rpm]. In addition, in sequence numbers N15 to N18, the finish shape of the workpiece is commanded.

Here, a finish dimension of an outer diameter of the workpiece for a position “X100.0” in the X-axis direction positioned by the sequence number N12 is “X50.0”, “X60.0”, or “X82.0”. That is, in the roughing cycle command, cutting is performed in a “−X-axis direction” and a “−Z-axis direction” from a machining start position “X100.0Z2.0”. That is, the acquisition unit 227 acquires cutting direction information “−X, −Z” indicating a cutting direction of the tool according to the roughing cycle command “G71”.

The calculation unit 225 calculates an adjustment offset value by adding the adjustment value Av to each of the tool offset value Ox in the X-axis direction and the tool offset value Oz in the Z-axis direction based on the cutting direction information “−X, −Z” acquired by the acquisition unit 227.

Therefore, even when both outer diameter machining and inner diameter machining are performed, it is sufficient that the operator inputs one adjustment value Av used to adjust each tool offset value in the X-axis direction and one adjustment value Av used to adjust each tool offset value in the Z-axis direction. As a result, the working time of the operator can be reduced, and productivity in the factory can be improved.

In the embodiment described above, the adjustment value storage unit 223 stores one adjustment value Av for adjusting the tool offset value in the X-axis direction and one adjustment value Av for adjusting the tool offset value in the Z-axis direction. However, the adjustment value storage unit 223 may store a plurality of adjustment values Av in association with each of the X-axis direction and the Z-axis direction. That is, the adjustment value Av may include a first adjustment value for adjusting at least one tool offset value among the plurality of tool offset values and a second adjustment value for adjusting at least one other tool offset value among the plurality of tool offset values.

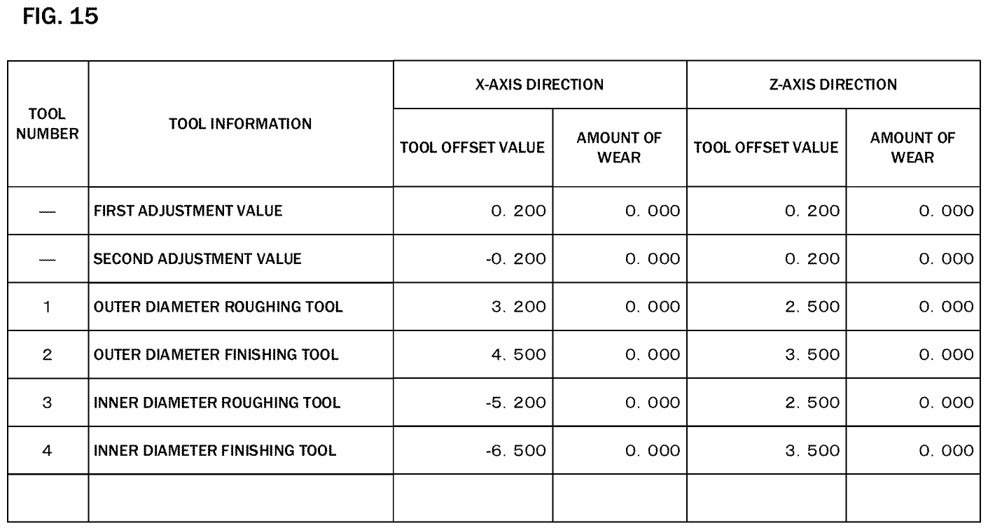

FIG. 15 is a diagram illustrating an example of a display screen when the adjustment value storage unit 223 stores a plurality of adjustment values Av. In the example illustrated in FIG. 15, the adjustment value storage unit 223 stores a first adjustment value and a second adjustment value. The calculation unit 225 calculates an adjustment offset value of each tool using the first adjustment value or the second adjustment value.

For example, the calculation unit 225 calculates an adjustment offset value by determining whether to add the first adjustment value or the second adjustment value to a tool offset value based on the tool offset value stored in association with each tool. When the tool offset value is a positive value, the calculation unit 225 adds the first adjustment value indicating a positive value to the tool offset value. In addition, when the tool offset value is a negative value, the calculation unit 225 adds the second adjustment value indicating a negative value to the tool offset value.

For example, the tool offset value Ox in the X-axis direction of each of the outer diameter roughing tool and the outer diameter finishing tool is a positive value. Therefore, the calculation unit 225 calculates an adjustment offset value by adding a first adjustment value Av1 indicating a positive value to the tool offset value Ox in the X-axis direction of each of the outer diameter roughing tool and the outer diameter finishing tool.

In addition, the tool offset value Ox in the X-axis direction of each of the inner diameter roughing tool and the inner diameter finishing tool is a negative value. Therefore, the calculation unit 225 calculates an adjustment offset value by adding a second adjustment value indicating a negative value to the tool offset value Ox in the X-axis direction of each of the inner diameter roughing tool and the inner diameter finishing tool.

In this way, even when the offset value storage unit 222 stores tool offset values of a plurality of outer diameter machining tools To, it is sufficient that the operator inputs one adjustment value Av for adjusting the tool offset values of the plurality of outer diameter machining tools To. Furthermore, even when the offset value storage unit 222 stores tool offset values of a plurality of inner diameter machining tools Ti, it is sufficient that the operator inputs one adjustment value Av for adjusting the tool offset values of the plurality of inner diameter machining tools Ti. As a result, the working time of the operator can be reduced, and productivity in the factory can be improved.

Further, the calculation unit 225 may calculate an adjustment offset value by determining whether to add the first adjustment value or the second adjustment value Av2 to the tool offset value of each tool based on information indicating the name or type of the tool. Further, the calculation unit 225 may calculate an adjustment offset value by determining whether to add the first adjustment value or the second adjustment value to the tool offset value of each tool based on cutting edge information of each tool. Further, the calculation unit 225 may calculate an adjustment offset value by determining whether to add the first adjustment value or the second adjustment value to the tool offset value of each tool based on cutting direction information acquired by the acquisition unit 227.

The offset value storage unit 222 may further store adjustment value application information in association with tool information of a plurality of tools. The adjustment value application information is information indicating which one of a plurality of adjustment values Av is used as the adjustment value Av to adjust the tool offset value of each tool.

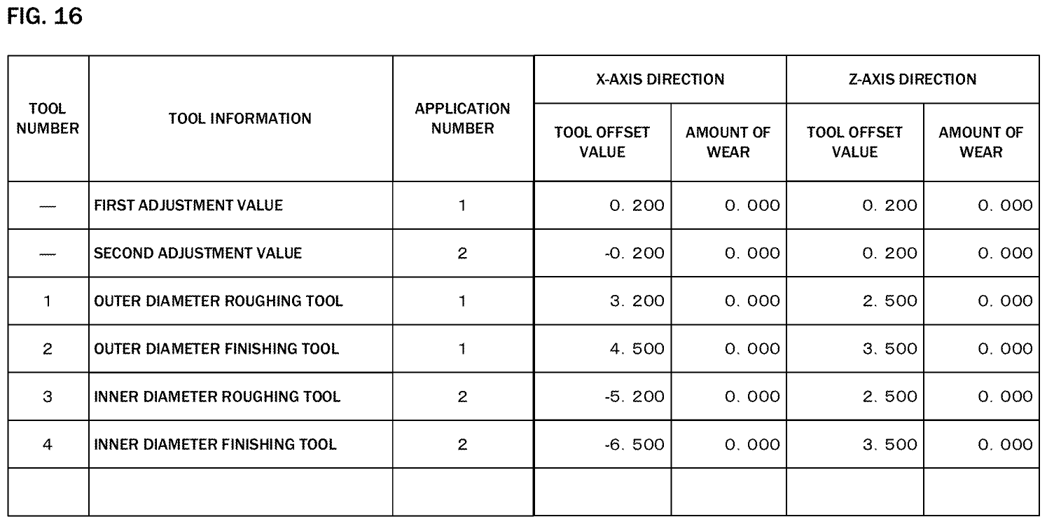

FIG. 16 is a diagram illustrating an example of a display screen when the offset value storage unit 222 stores the adjustment value application information. On the display screen, an application number is displayed as the adjustment value application information between a column in which the tool information is displayed and a column in which the tool offset value Ox in the X-axis direction is displayed.

Number “1” and number “2” are assigned to a first adjustment value and a second adjustment value, respectively. In addition, number “1” or number “2” indicating which one of the first adjustment value and the second adjustment value is used to adjust each tool offset value is stored in association with a tool offset value of each tool. That is, based on number “1” or number “2” stored in association with the tool offset value of each tool, the calculation unit 225 determines which one of the first adjustment value or the second adjustment value is added as the adjustment value Av to the tool offset value of each tool.

In this way, even when the offset value storage unit 222 stores the tool offset values of the plurality of outer diameter machining tools To, it is sufficient that the operator inputs one adjustment value Av for adjusting the tool offset values of the plurality of outer diameter machining tools To. Furthermore, even when the offset value storage unit 222 stores the tool offset values of the plurality of inner diameter machining tools Ti, it is sufficient that the operator inputs one adjustment value Av for adjusting the tool offset values of the plurality of inner diameter machining tools Ti. As a result, the working time of the operator can be reduced, and productivity in the factory can be improved.

Note that, even though two adjustment values Av are displayed in the example illustrated in FIG. 16, the adjustment value storage unit 223 may store three or more adjustment values, and the three or more adjustment values may be displayed on the display screen.

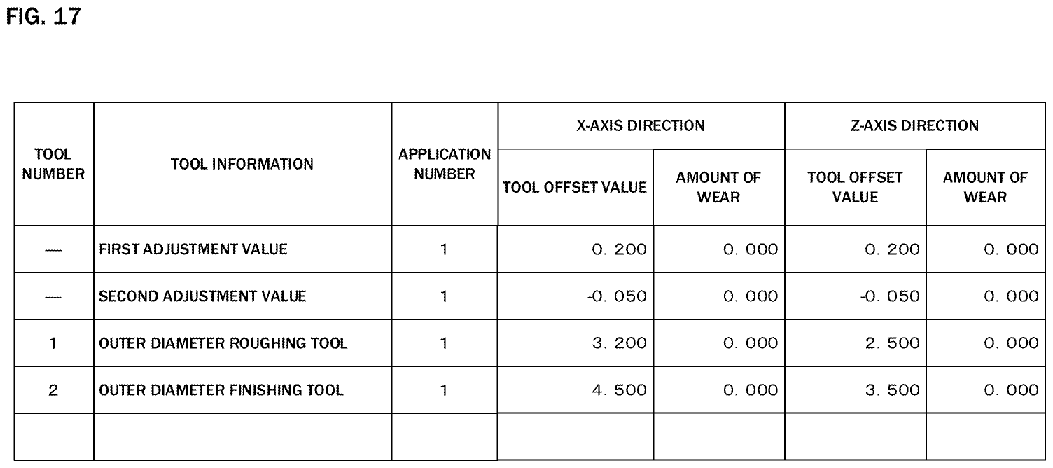

In addition, a plurality of adjustment values Av may be applied to one tool offset value. For example, as illustrated in FIG. 17, both the first adjustment value and the second adjustment value may be added to the outer diameter roughing tool and the outer diameter finishing tool. In this case, during the first machining, the operator sets the first adjustment value to 0.200 [mm] and the second adjustment value to 0.000 [mm]. Then, after measuring an outer diameter dimension, when the outer diameter dimension is larger than a design dimension by 0.050 [mm], the operator sets the second adjustment value to −0.050 [mm]. That is, the first adjustment value can be used as an adjustment value used in the first machining, and the second adjustment value can be used as an adjustment value for adjusting the first adjustment value.

In addition, the offset value storage unit 222 may store adjustment value application information and cutting edge information in association with the tool offset value of each tool. In this case, the calculation unit 225 determines which one of the first adjustment value or the second adjustment value is used as the adjustment value Av to adjust each tool offset value based on the adjustment value application information. Further, based on the cutting edge information, the calculation unit 225 determines whether to add the first adjustment value or the second adjustment value to each tool offset value, or to subtract the first adjustment value or the second adjustment value from each tool offset value, and calculates an adjustment offset value.

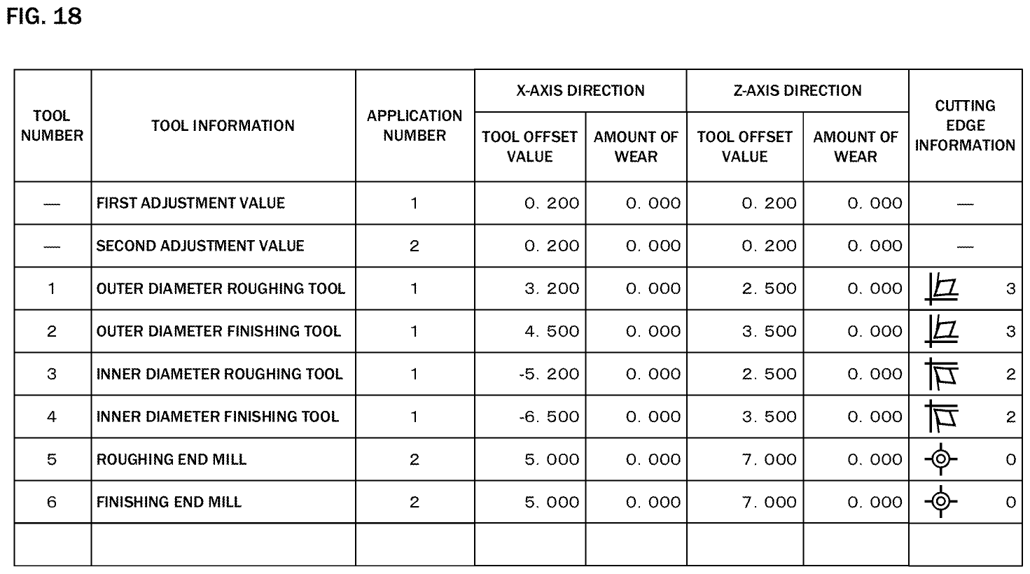

FIG. 18 is a diagram illustrating an example of a display screen when the offset value storage unit 222 stores adjustment value application information and cutting edge information in association with the tool offset value of each tool. In the example illustrated in FIG. 18, the adjustment value storage unit 223 stores number “1” and number “2” in association with the first adjustment value and the second adjustment value, respectively.

In addition, the offset value storage unit 222 stores the adjustment value application information indicating which one of the first adjustment value or the second adjustment value is used as the adjustment value Av to adjust the tool offset value in association with the tool offset value of each tool. Furthermore, the offset value storage unit 222 stores the cutting edge information indicating a direction of the tool in association with the tool offset value of each tool.

The calculation unit 225 adds the first adjustment value or the second adjustment value to the tool offset value of each tool or subtracts the first adjustment value or the second adjustment value from the tool offset value of each tool based on the adjustment value application information and the cutting edge information stored in association with the tool information of each tool.

In the example illustrated in FIG. 18, adjustment value application information “1” is stored in association with an outer diameter roughing tool, an outer diameter finishing tool, an inner diameter roughing tool, and an inner diameter finishing tool. Therefore, the first adjustment value is added to each of the tool offset values of the outer diameter roughing tool, the outer diameter finishing tool, the inner diameter roughing tool, and the inner diameter finishing tool, or the first adjustment value is subtracted from each of the tool offset values thereof.

Further, cutting edge information “3” is stored in association with the outer diameter roughing tool and the outer diameter finishing tool. Therefore, the first adjustment value of 0.200 [mm] is added to the tool offset value in the X-axis direction of each of the outer diameter roughing tool and the outer diameter finishing tool. Further, cutting edge information “2” is stored in association with the inner diameter roughing tool and the inner diameter finishing tool. Therefore, the first adjustment offset value of 0.200 [mm] is subtracted from the tool offset value in the X-axis direction of each of the inner diameter roughing tool and the inner diameter finishing tool.

Adjustment value application information “2” is stored in association with each of a roughing end mill and a finishing end mill. Therefore, the second adjustment value of 0.200 [mm] is added to tool radius compensation of each of the roughing end mill and the finishing end mill. Note that, when the tool is a rotary tool such as a milling tool, a tool offset value displayed in a column of the tool offset value in the X-axis direction is tool radius compensation, and a tool offset value displayed in a column of the tool offset value in the Z-axis direction is tool length compensation.

Therefore, even when machining is performed using respective machining tools for turning and milling, it is sufficient that the operator inputs one adjustment value for adjusting each of tool offset values of the tools for turning and milling. As a result, the working time of the operator can be reduced, and productivity in the factory can be improved.

### EXPLANATIONS OF LETTERS OR NUMERALS

1 MACHINE TOOL
2 CONTROLLER
3 DISPLAY DEVICE
4 INPUT DEVICE
5 SERVO AMPLIFIER
6 SERVOMOTOR
7 SPINDLE AMPLIFIER
8 SPINDLE MOTOR
9 TOOL PRESETTER
10 PERIPHERAL DEVICE
201 CPU
202 BUS
203 ROM
204 RAM
205 NONVOLATILE MEMORY
206 FIRST INTERFACE
207 SECOND INTERFACE
208 AXIS CONTROL CIRCUIT
209 SPINDLE CONTROL CIRCUIT
210 THIRD INTERFACE
211 PLC
212 I/O UNIT
221 INPUT RECEPTION UNIT
222 OFFSET VALUE STORAGE UNIT
223 ADJUSTMENT VALUE STORAGE UNIT
224 DISPLAY UNIT
225 CALCULATION UNIT
226 CONTROL UNIT
227 ACQUISITION UNIT
Ox TOOL OFFSET VALUE IN X-AXIS DIRECTION
Oz TOOL OFFSET VALUE IN Z-AXIS DIRECTION
C REFERENCE POINT
To OUTER DIAMETER MACHINING TOOL
Tm MILLING TOOL
Ti INNER DIAMETER MACHINING TOOL
W WORKPIECE
Ol TOOL LENGTH COMPENSATION
Od TOOL RADIUS COMPENSATION
Av ADJUSTMENT VALUE

1. A controller comprising:
an offset value storage unit configured to store a plurality of tool offset values associated with a plurality of tools, respectively;
an adjustment value storage unit configured to store an adjustment value used to adjust the plurality of tool offset values; and
a calculation unit configured to calculate a plurality of adjustment offset values obtained by adjusting the plurality of tool offset values using the adjustment value.

2. The controller according to claim 1, wherein the calculation unit calculates the plurality of adjustment offset values by adding the adjustment value to each of the plurality of tool offset values or subtracting the adjustment value from each of the plurality of tool offset values based on the plurality of tool offset values.

3. The controller according to claim 1, wherein:
the offset value storage unit further stores a plurality of pieces of tool information associated with the plurality of tools, respectively; and
the calculation unit calculates the plurality of adjustment offset values by adding the adjustment value to each of the plurality of tool offset values or subtracting the adjustment value from each of the plurality of tool offset values based on the plurality of pieces of tool information.

4. The controller according to claim 3, wherein the plurality of pieces of tool information is information indicating a name or a type of each of the plurality of tools.

5. The controller according to claim 3, wherein the plurality of pieces of tool information is cutting edge information indicating a facing direction of a cutting edge of each of the plurality of tools.

6. The controller according to claim 1, further comprising an acquisition unit configured to acquire cutting direction information indicating a cutting direction of each of the plurality of tools from a machining program,
wherein the calculation unit calculates the plurality of adjustment offset values by adding the adjustment value to each of the plurality of tool offset values or subtracting the adjustment value from each of the plurality of tool offset values based on the cutting direction information.

7. The controller according to claim 1, wherein the adjustment value includes a first adjustment value for adjusting at least one tool offset value among the plurality of tool offset values and a second adjustment value for adjusting at least one other tool offset value among the plurality of tool offset values.

8. The controller according to claim 7, wherein the offset value storage unit further stores adjustment value application information indicating which one of the first adjustment value and the second adjustment value is used, the plurality of adjustment offset values being calculated based on the one adjustment value.
